(19) United States
(12) Patent Application Publication
(10) Pub. No.: US 2020/0027329 A1
(43) Pub. Date: Jan. 23, 2020

(54) INTERFACING PERIPHERAL DEVICES USED IN A HAZARDOUS ENVIRONMENT

(71) Applicant: Wearable Technology Limited, Leicester (GB)

(72) Inventor: Michael John LYNCH, Leicester (GB)

(21) Appl. No.: 16/587,165

(22) Filed: Sep. 30, 2019

Related U.S. Application Data
(63) Continuation-in-part of application No. PCT/GB2018/000054, filed on Mar. 29, 2018.

(30) Foreign Application Priority Data
Mar. 31, 2017 (GB) 1705217.6

(51) Int. Cl. G08B 21/12; G08B 5/22; H04W 4/38; H04W 4/80; H04B 5/00; A41D 1/02; A41D 13/01

(52) U.S. Cl. CPC G08B 21/12; G08B 5/224; H04W 4/38; A41D 13/01; H04B 5/0068; A41D 1/02; H04W 4/80

(57) ABSTRACT

A peripheral device (701) is knocked against a control unit (704), whereafter the peripheral device is attached to an item of clothing, such as a jacket. The control unit is connected to a wiring loom in the jacket, to operate attached light-emitting devices. The control unit is located within the jacket to receive environmental data during an operation shift. In response to the knocking step, the control unit energizes a passive transponder attached to the peripheral device and the passive transponder transmits held signature data in response to being energized. The control unit stores the transmitted signature data and the control unit only records environment data that includes stored signature data.

### CROSS REFERENCE TO RELATED APPLICATIONS

This application is a continuation-in-part of and claims priority from international patent application PCT/GB2018/000054 filed Mar. 29, 2018, which claims priority from British patent application 1705217.6 filed Mar. 31, 2017. The entire contents of international patent application PCT/GB2018/000054 and British patent application 1705217.6 are incorporated herein by way of reference.

### BACKGROUND OF THE INVENTION

The present invention relates to a system for interfacing peripheral devices used in hazardous environments.

It is known to use peripheral devices in hazardous attached to clothing in order to identify and quantify hazards. These hazards may be due to the non-exclusive presence of toxic gases, radiation, noise, vibration and moving machinery.

It is also known to provide items of clothing that include personal data networks, thereby allowing devices supported by an operative to communicate with each other and convey appropriate data to external base stations and control rooms. However, a problem exists in that many known peripheral devices do not include appropriate interfaces for communicating in this way. For example, some devices of this type are configured to collect data over an operational period and then transfer this collected data at the end of a working shift. Other devices only raise a local alarm or transmit to a specific piece of equipment without including any interfaces for communicating with a network. Consequently, without modifying peripheral devices or constructing new peripheral devices, it is not possible for these devices to operate within existing personal area networks.

Devices are becoming available that broadcast environmental data using non-paired wireless protocols such as Bluetooth low energy (BLE). However, such an environment also creates problems in that each control unit may receive broadcasts of this type from many sources.

### BRIEF SUMMARY OF THE INVENTION

According to an aspect of the present invention, there is provided an apparatus for use in a hazardous environment, comprising: a control unit including a processor and a battery; an item of clothing having light-emitting devices and a wiring loom for connecting said light-emitting devices to said control unit; and a peripheral device attached to said item of clothing, wherein: said peripheral device is configured to generate environmental data and broadcast said environmental data after predetermined intervals by radio transmission; each said broadcast includes signature data identifying the peripheral device; said peripheral device includes a passive transponder including a data storage device for storing said signature data; said control unit includes an energizing device for energizing said transponder, a receiver for receiving data transmitted from said transponder and a data storage device for storing transmitted signature data; and said processor is configured to only record environmental data that includes previously stored signature data.

### BRIEF DESCRIPTION OF SEVERAL VIEWS OF THE DRAWINGS

The invention will now be described way of example only, with reference to the accompanying drawings, of which:

FIG. 1 shows an example of a peripheral device;

FIG. 2 shows procedures for tagging peripheral devices;

FIG. 3 illustrates a system for receiving data from peripheral devices used in hazardous environments;

FIG. 4 shows a protocol diagram identifying communications that take place within the environment identified in FIG. 3;

FIG. 5 shows control units receiving charge from a charging unit;

FIG. 6 details the internal components of a control unit;

FIG. 7 illustrates an audio-monitoring device;

FIG. 8 show operations performed by a control unit to achieve an association;

FIG. 9 shows an item of clothing with a peripheral device attached thereto;

FIG. 10 shows operations performed by a processor identified in FIG. 6;

FIG. 11 details the procedure identified in FIG. 10 for collecting operational data;

FIG. 12 shows procedures performed at a base station in order to communicate with control units;

FIG. 13 details procedures identified in FIG. 12 for performing an authentication process;

FIG. 14 details procedures identified in FIG. 12 for processing operational data;

FIG. 15 shows an item of clothing in the form of a jacket; and

FIG. 16 shows the jacket of FIG. 15 in a fastened condition.

### DETAILED DESCRIPTION OF EXAMPLE EMBODIMENTS

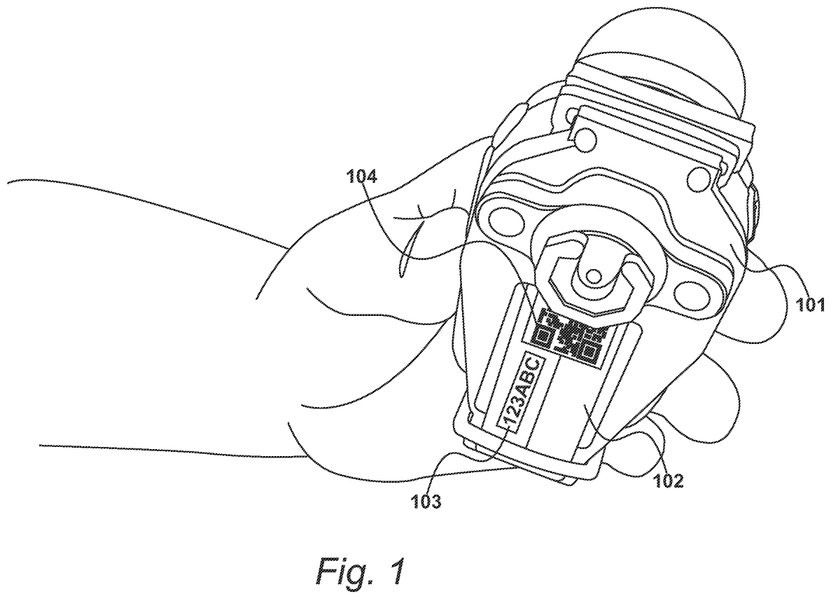

### FIG. 1

An example of a peripheral device 101 is shown in FIG. 1. This device is configured to measure ambient sound levels. Measured sound levels may be displayed locally and an interface may be provided to allow sound levels to be viewed on a mobile device, such as a mobile cellular telephone. However, for operational purposes, the peripheral device 101 is primarily designed to perform an end-of-shift data download, identifying sound levels that have occurred over a working day. Thus, the peripheral device may assist an operative and provide a warning to an operative if sound levels are becoming dangerous. However, the primary intended purpose of the device is to retain data as evidence to the effect that working conditions have been consistent with accepted practice and that excessive sound levels have not been present for excessive periods of time.

Similar peripheral devices are available for measuring other hazards in a similar way. For example, devices are available for detecting gas concentrations. Data collected over a working shift is downloaded, typically via a USB cable (which may also be present for charging purposes) or via a short-range wireless connection. Increasingly, devices of this type are being provided with protocols for allowing data downloads to occur in accordance with established low energy protocols.

The present system is configured to collect historical data, on a shift by shift basis. However, in addition, the present system also collects and processes real-time data such that, if a hazard condition is identified, it is possible for alarm conditions to be raised and for operatives to be notified accordingly.

Often operatives are working in teams such that by taking this real-time approach, it is possible to notify all team members if one particular member encounters a hazardous condition. In extreme cases, an operative may be incapacitated and assistance may be provided by other operatives working in the team. It is also possible for an operative to be provided with means for manually identifying an emergency condition such that, again, a base station may be notified and communications may be relayed to other operatives within the team.

It is therefore appreciated that it would be helpful if existing peripheral devices were provided with enhanced communication capabilities. However, until then, measures must be adopted that achieve advanced levels of operation while not relying on any communication enhancements made by the manufacturers of the peripheral devices. In addition, the peripheral devices must not in any way be modified or compromised, given that existing warranties could become void and a further level of certification could be required for operating within hazardous environments.

To achieve this, an embodiment adopts strategies to allow existing peripheral devices to operate securely and safely within real-time environments without in any way compromising the warranties and certificates of the devices themselves.

Given that end-of-shift downloads are possible using Bluetooth communication, it is known that peripheral devices are provided with addressing codes and passwords which, when submitted over established communication channels, allow wireless access to stored data. Usually, an access of this type is made at the end of a shift, such that the data download constitutes a full operational period. To achieve real-time operation, in an embodiment, requests of this type are made regularly within a local area network such that, for example, instead of a data download occurring once at the end of a shift, data downloads always take place after a predetermined interval of, say, ten-minutes. In practice, this period may be adjusted to optimise battery life while at the same time being sufficiently real-time to address particular hazards.

Given that systems of this type must be certified and operate in accordance with strict standards, a network operator may wish to take steps to reduce the risk of non-certified equipment being connected and allowed to function during operational periods. If peripheral devices were provided that clearly identified access codes and passwords etc., it would be possible for these devices to be cloned without having their validity and operational systems checked. Thus, a second approach of an embodiment is to ensure that this information is not readily available and can only be obtained by a data transfer from a base station.

As illustrated in FIG. 1, the peripheral device 101 has a tag 102 attached thereto. The tag includes an eye-readable code 103 that is unique to the device. In addition, the same code can be read using a camera focused on a QR code 104. Furthermore, beneath tag 102 a near field radio communication device has been embedded. Thus, it is possible for the identification of the tag to be made from one of three sources. However, it should be appreciated, that these codes are only used to identify the peripheral device 101 to a base station and do not in themselves identify access addresses for reading the information stored on the device.

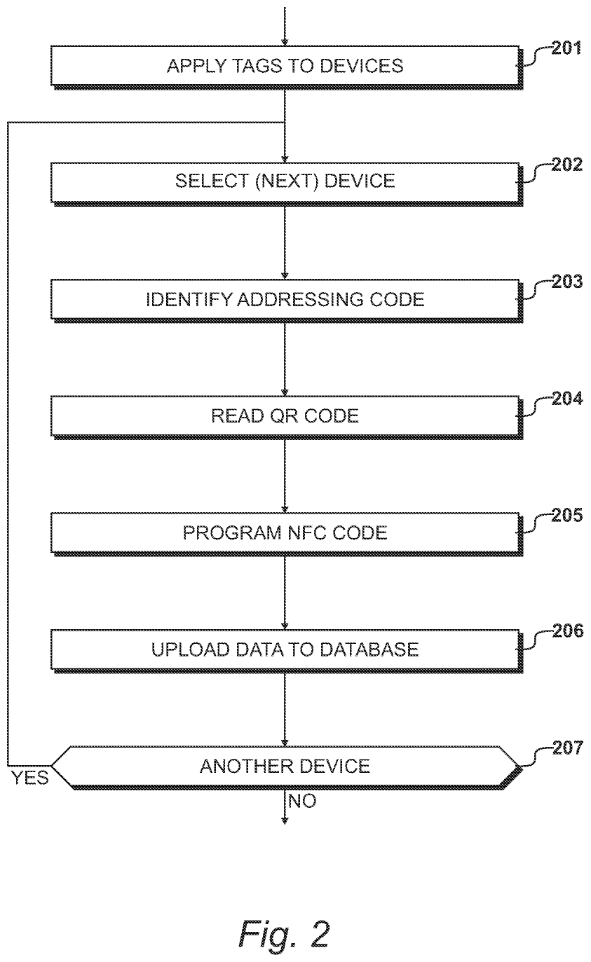

### FIG. 2

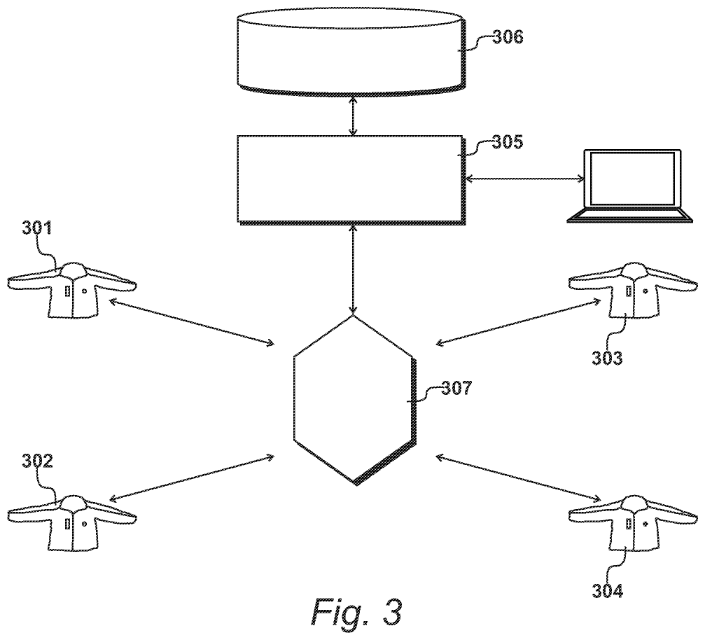

Peripheral devices of the type previously described are obtained in bulk from manufactures. The devices allow data to be downloaded using Bluetooth protocols. To achieve this, a media access control address (MAC-48) is provided and, in this embodiment, the MAC address is stored by a base station database; as described with reference to FIG. 3. The peripheral devices are not modified in any way and communication is achieved via the interface provided. As previously described, these interfaces are generally intended for end-of-shift data downloads to occur. However, in the present embodiment, this mechanism is used more frequently to achieve a substantially real-time form of operation.

When received, peripheral devices are retained in store until required. At step 201 a tag of the type identified in FIG. 1 is applied to the device. Each peripheral device is given a unique tag, representing a code that is only meaningful within the environment of the present embodiment.

At step 202 a device is selected and for the selected device, access and addressing codes are identified at step 203. At step 204, the QR code 104 is read, possibly using a device such as a tablet having a camera, along with instructions for interpreting the QR code 104. This identifies a unique code that should be consistent with the eye-readable code 103.

At this stage, the tag 102 includes a blank near field communication (NFC) chip. At step 205, the NFC chip within the tag 102 is programmed with details of the code read at step 204. Thereafter, at step 206, data is uploaded to a database via an internet connection and possibly via a web-based portal. Thus, in this way, the database is capable of identifying the MAC address for the peripheral device in response to receiving the unique code applied thereto.

After step 206, the QR code 104 has effectively served its purpose and the unique code will be identified in operational situations using the NFC chip. It is also appreciated that NFC chips provide substantially higher storage capabilities than that required for just recording the unique code. In an embodiment, it would be possible to include the actual MAC address as part of this stored data. Alternatively, it would be possible to store an encrypted version of the MAC address such that, in some situations, it would be possible to achieve remote deployment without reference to a central base station. However, in some applications, it is only be possible to obtain the MAC address by interrogating the base station such that, for an operational network, operators are assured that all devices connected thereto are authorized and meet necessary standards, such that secure and reliable operation may be assured.

At step 207 a question is asked as to whether another device is to be considered and a further selection is made at step 202 when the question is answered in the affirmative. Thus, by repeating the procedure identified in FIG. 2, the complete batch of devices may be located in storage ready for use, with their operational codes retained in a base station database.

### FIG. 3

A system for receiving data from peripheral devices used in hazardous environments is illustrated in FIG. 3. Items of clothing 301, 302, 303 and 304 include a machine-readable code. Peripheral devices are attachable to these items of clothing and are configured to collect environmental data and download this data in response to receiving a data download request. Each peripheral device also contains a machine-readable code, of the type described with reference to FIG. 1.

Control units are interchangeably supportable by the items of clothing and include code reading devices for reading the machine-readable codes from the peripheral devices and from the items of clothing.

A base station 305 is arranged to maintain a database system 306 identifying operatives, the items of clothing (301 to 304) peripheral devices and control units. A cellular telephony network 307 allows the base station 305 to communicate with the control units supported by each item of clothing.

A selected control unit reads a first machine-readable code from a first selected peripheral device and transmits this first machine-readable code to the base station. The selected control unit also reads a second machine-readable code from a selected item of clothing and transmits this second machine-readable code to the base station. The base station 305 determines whether the selected item of clothing can be used in combination with the selected control unit and the selected peripheral device. Thereafter, the base station transmits an access address to the control unit for the selected peripheral device if the determination is made positive. However, the base station will not transmit an access code and will raise an alarm condition if the determination is negative.

When using Bluetooth, the access code includes a media access control (MAC) address for the selected peripheral device. Thus, in this embodiment, the media access control address is not available locally and can only be identified by communicating with the base station. The base station is therefore in a position to determine whether the combination is valid and will prevent the MAC address being delivered if any of the required operational constraints have not been met.

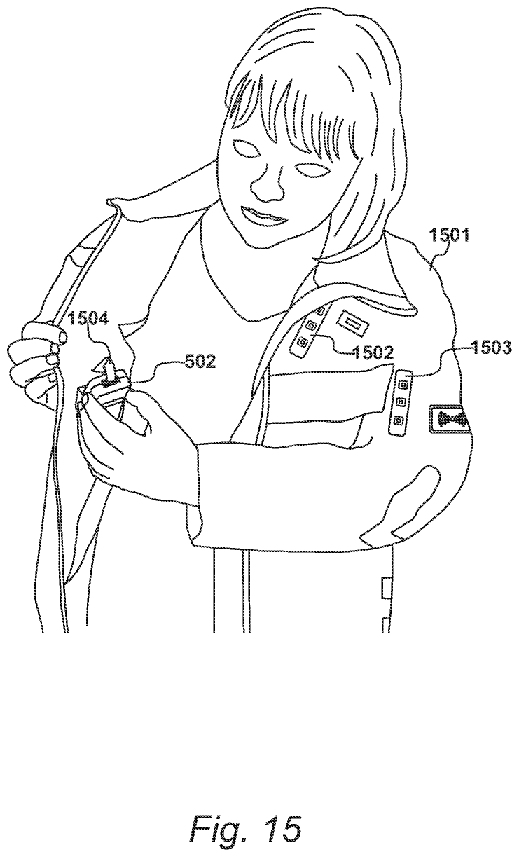

In practice, it is assumed that each operative will receive their own item of clothing. This may take the form of a jacket (of the type described with reference to FIG. 15) for example. Thus, each item of clothing includes a second machine-readable code which identifies that particular item of clothing uniquely and thereby identifies a particular operative. Thus, a determination could be made that is negative if, for whatever reason, the particular operative should not be working or should not be working on a particular project.

Furthermore, a determination may be negative if a control unit does not appear to be functioning correctly. However, primarily, a determination will be negative if, for whatever reason, an incorrect peripheral device has been attached to the item of clothing. Thus, situations may be identified where a particular operative is not authorised to use a particular peripheral device or an attached peripheral device is considered inappropriate for the activity to be performed. In any of these situations, the determination will be negative and the operative will not be permitted to enter the working environment.

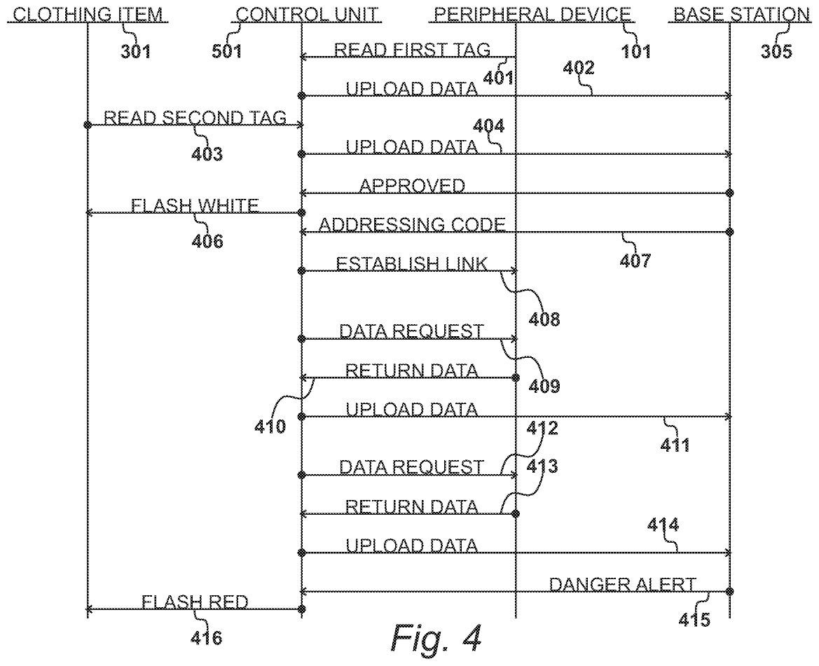

### FIG. 4

A protocol diagram is shown in FIG. 4, identifying communications that take place within the environment identified in FIG. 3. The protocol diagram illustrates a method of transmitting data from a peripheral device attached to an item of clothing to a remote base station via a control unit supported by the item of clothing.

A control unit is brought into close proximity with a selected peripheral device and a reading operation 401 is performed. A data upload 402 from the control unit to a base station 305 then occurs. The control unit is then brought into proximity with a second tag attached to an item of clothing. The second tag is read and again a tag data upload 404 to the base station 305 occurs.

At the base station 305, an assessment is made as to whether the operative is permitted to use the selected peripheral device with the selected control unit. For the purposes of this example, a positive approval is made, resulting in confirmation-data 405 being transmitted from the base station back to the control unit.

In an embodiment, the item of clothing includes light emitting diodes that are activated, in selected colours, by the control unit. Thus, in this embodiment, after receiving an approval, the control unit issues an energization-signal 406 to the light-emitting-diodes causing them to flash white. In an embodiment, if approval is not given, the control unit may emit a buzzing sound and light-emitting diodes may be caused to flash red.

After approval, the base station 305 downloads addressing-code data 407. In an embodiment, these addressing codes include a MAC address for allowing communication using Bluetooth protocols. The control unit is now in a position to communicate with a peripheral device and a communication link 408 is established.

The combination is now operational and the peripheral device, during a working shift, will collect operational data. Periodically, in order to obtain real-time data, a data request 409 is made from the control unit to the peripheral device 101. The peripheral device interprets this as an end-of-shift request and performs a data return 410 of stored data. Data stored on the peripheral device is erased, thereby allowing the peripheral device to store more data. A data upload 411 then occurs from the control unit to the base station 305.

Should this mode of communication fail, the peripheral device will continue to record operational data, which may then be downloaded at the end of the shift in a conventional manner. However, following the present embodiment, data requests continue to be made periodically, possibly every ten minutes. Thus, a further data request 412 is made resulting in a further data return 413 and a further data upload 414.

For the purposes of this example, it is assumed that the further data upload 414 includes an indication that a hazard has been detected and that operatives should address this hazard or withdraw from the environment. Thus, a danger alert 415 is downloaded from the base station to the control unit. This generates an alarm 416 at the control unit which generates an audible buzz and causes the light-emitting diodes to flash red. In an embodiment, the control unit is also provided with an audio interface to provide audio communication with a headset. Thus, a voice message may be conveyed to operatives identifying the nature of the hazard and providing further instructions.

In the environment described with reference to FIGS. 3 and 4, a communication channel is established between a peripheral device and a control unit of the type used to perform an end-of-shift data download of historical data. Data downloads of this type are requested periodically from the peripheral device to the control unit. Furthermore, this downloaded data is relayed from the control unit to the remote base station to provide regularly updated data to the base station. The base station identifies the peripheral device by receiving a first code read from a first near field radio device attached to the peripheral device by the control unit. The base station returns addressing data for the peripheral device to the control unit to perform the step of establishing a communication channel. Thus, in this way, it is only possible for the control unit to communicate with the peripheral device if appropriate codes have been received from the base station, after checking that all of the devices are authentic and the combination is appropriate for the operations to be performed during a working shift.

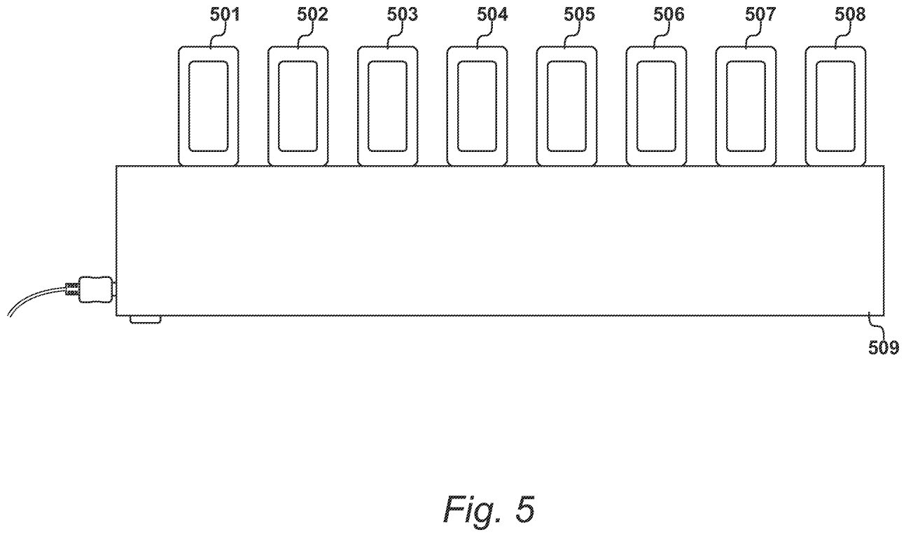

### FIG. 5

Control units 501 to 508 are shown in FIG. 5, connected to a bulk-charging device 509. Each control unit, including control unit 501, includes a micro USB input socket used for charging purposes.

During an operational period, the control unit 501 will have associated with a particular item of clothing and will have paired with a peripheral device.

If, during operation, communication is lost, this pairing information is retained, so that communication may be re-established. However, upon inserting a control unit into the bulk-charging device 509, this pairing data is erased such that, at the start of a new shift, the whole association and pairing exercises may be repeated with a different item of clothing and with a different peripheral device.

It is assumed that operatives will retain the same item of clothing (which may have been selected for size and fit etc.) but they may select any appropriate control unit (501 to 508) and may select any appropriate peripheral device(s). Furthermore, it is not necessary for operatives to perform any complex procedures to achieve the required pairing, provided that the devices are brought into close proximity to allow their near field devices to be read. It should also be appreciated that other devices providing similar functionality may be adopted and the term “near field devices” should be interpreted in a broad sense. For example, the phrase is intended to include devices usually identified as radio frequency identification devices (RFID devices), again providing a passive form of local radio communication. Furthermore, it is anticipated that similar devices may be developed in future that are identified by alternative wording in order to designate a particular operational protocol.

Thus, in an embodiment, the base station identifies an item of clothing by receiving a second code from the control unit; the control unit having read a second near field radio device attached to the item of clothing. Thus, prior to entering the operation environment, it is necessary for an operative to bring a control unit into close proximity with a peripheral device and then into close proximity with a tag attached to the item of clothing. These procedures can be conducted in any order. However, in an embodiment, the control unit is then attached to a loom within the item of clothing, as described with reference to FIG. 15, thereby allowing embedded devices, such as light-emitting diodes, to be activated.

In an embodiment, the control unit is retained within a pocket and this pocket may be waterproof, thereby removing requirements for providing waterproofing for the casing of the control unit itself. The second tag may be placed in close proximity to this pocket, such that the code may be read automatically after connection of the control unit to the loom and the insertion of the control unit into a pocket. Thus, in practice, it may be preferable for an operative to pair the control unit with a peripheral device before attaching the control unit to the loom.

Addressing data is only returned back to the control unit after making a determination at the base station as to whether a selected peripheral device can be used with a presented item of clothing. In an embodiment, the control unit is provided with a near field radio scanning device and this scanning device is activated for a predetermined period of time after removing a selected control unit from the bulk-charging device 509. Thus, after removing a control unit, an operative has a predefined window for associating and pairing the control unit with other devices, whereafter the scanning device is deactivated to conserve power. Should the operative be distracted and a timeout condition arise, it becomes necessary for the control unit to be returned to the charging station and the process repeated.

Upon connecting the control unit to the embedded loom, the control unit should have successfully associated with the other devices and a positive determination should have been received from the base station. Thereafter, in an embodiment, upon connecting a selected control unit to power and data cables controlling operation of light emitting devices embedded within the item of clothing, the light emitting devices are activated, showing that connection to the peripheral device has been successful.

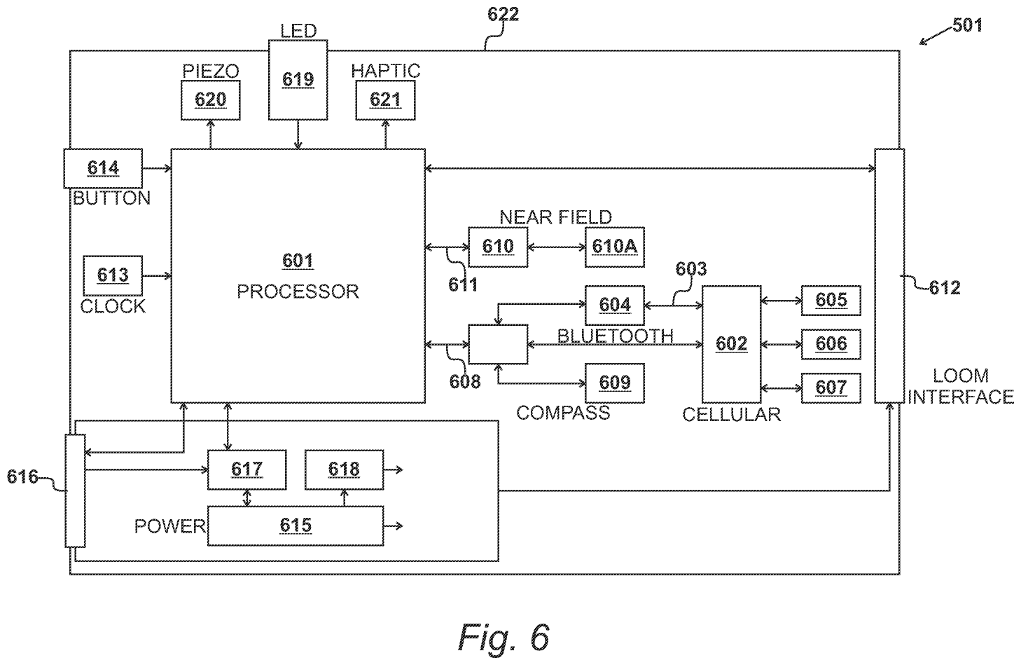

### FIG. 6

The control unit 501 provides an apparatus for communicating with peripheral devices attached to an item of clothing for use in hazardous environments. The control unit includes a processor 601 that may be implemented as an STM32 microcontroller. This provides a significant processing capability, while minimizing power demands, as required for the cellular and local communications that take place. A code library for this device also facilitates code porting.

A cellular communications module (cellular module 602) is provided for communicating with the remote base station 305. The cellular module 602 may be a SIMCOM module providing G3 GSM and enhanced GPRS connections, along with GPS tracking. A digital communication link 603 provides digital audio to a dual Bluetooth® module 604.

The cellular module 602 is provided with a GSM antenna 605, a GPS antenna 606 and a cellular SIM card 607. An asynchronous digital communication channel 608 allows the processor 601 to communicate with the cellular module 602, the dual Bluetooth module 604 and an E-compass 609. In an embodiment, the E-compass 609 is used to identify falls and other movements made by an operative. In further embodiments, the E-compass could also be deployed for dead reckoning purposes, allowing the tracking of operatives to continue when indoors or in other environments where a GPS signal is not available.

A near field radio communication module (near field module 610) is provided with an NFC antenna 610A. Again, a digital communication link 611 allows communication between the near field radio communication module 609 and the processor 601.

When operational, the processor 601 controls the near field radio communication module 609 to read a first code from a peripheral device 101. The processor then controls the cellular module 602 to transmit this first code to the remote base station 305. The near field radio communication module is controlled again to read a second code from an item of clothing. The cellular communication device is again controlled to transmit this second code to the remote base station. It is then necessary to wait for a positive determination from the base station 305.

Assuming a determination is positive, an access address is received from the remote base station via the cellular module 602. This access address data is of a type used to perform an end-of-shift data download from the peripheral device and by making repeated use of this, it is possible to achieve a near real-time operation of the device without in any way changing its operational characteristics. Thus, the access address is used periodically to demand the download of data from the peripheral device, via the dual Bluetooth module 604, which is then relayed to the base station via the cellular module 602.

In an embodiment, a physical interface 612 is provided, implemented as an IDC connector, for supplying power and data to devices connected to a loom embedded within the item of clothing. These embedded devices may include light emitting devices. In an embodiment, the embedded devices also include light detecting devices, wherein the light emitting devices are controlled in response to output signals from the light detecting devices. Furthermore, upon receiving a positive determination to allow access to the peripheral device, the processor 601 may be configured to cause the light emitting devices to flash, thereby confirming to an operative that the system has become functional. In an embodiment, a clock signal to the processor 601 is provided by a twelve-megahertz crystal 613.

A single large button 614 provides a single point of user interface and may cover seventy percent of an available surface area. In an embodiment, operation of the large button 614 will change light-emitting-diode flash rates with a single short press and will allow the brightness of these devices to be changed if double clicked. Furthermore, the large button 614 may activate an alarm if pressed and held for more than three seconds.

A lithium-polymer cell battery 615 is charged from a micro USB socket 616 via a charge controller 617. A regulated output of three volts is also provided by a regulator 618, in addition to a direct output, that typically has a voltage of around three-point-seven (3.7) volts.

A light-emitting indicator 619 provides an indication of charging conditions. Thus, light-emitting indicator 619 may glow green when charging and then glow red when fully charged. Consequently, operatives would be encouraged to select control units from the charging device 509 that indicate a green condition.

A piezo-electric device 620 provides audible alerts of typically 90 dB. A short beep may also be used to acknowledge pairing of Bluetooth devices and dangerous situations may be identified by constant long beeps, in addition to audio messages transmitted to a headset.

A haptic motor 621 provides haptic feedback and notifications, that are considered to be particularly useful in noisy environments. To enhance results, the haptic motor 621 is mounted directly to an enclosure 622 of the control unit.

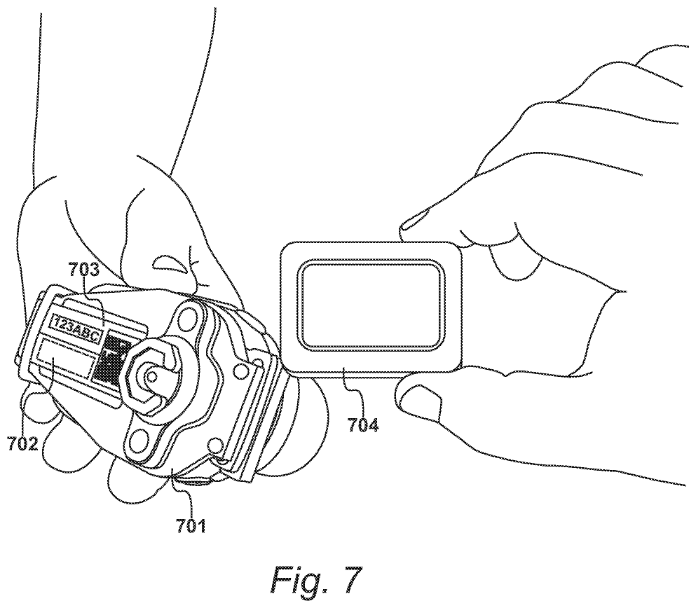

### FIG. 7

An alternative audio-monitoring device 701 is shown in FIG. 7 which, as a proprietary device, is configured to periodically broadcast audio-level data using a Bluetooth Low Energy (BLE) protocol. Essentially, this is an unpaired Bluetooth radio data transmission protocol. Thus, it is relatively easy to receive these transmissions, from which the relevant data can be recorded. However, in the environment described with reference to FIG. 4, many jackets mat be within transmission range of each other's peripheral devices and two or more peripheral devices may be included on each jacket.

To ensure that a control unit only records data from peripheral devices on an associated jacket and that the type of the device is identified, an association is performed, in accordance with this embodiment, that is different from the pairing operations previously described. A conventional pairing would result in the two devices only communicating with each other. With an association of this type, all of the peripheral devices transmit, but the control unit is selective in terms of which peripheral devices it will actual listen to.

In this embodiment, the peripheral device supports a passive NFC chip 702, held beneath a sticker 703. In this mode, the NFC chip performs as a transponder, such that stored data is transmitted in response to an energizing signal being received. The energizing signal is supplied by a control unit 704 and in this embodiment, the control unit 704 is prompted to activate an energizing transmission in response to being knocked; with the knocking or sudden movement being detected by the e-compass 609. For communication to take place, the peripheral device 701 and the control unit need to be in close proximity; typically, within a range of ten-centimetres (10 cm). Thus, operatives are encouraged to knock the two devices together, as shown in FIG. 7.

The control unit 704 includes a processor 601 and a battery 615 and operates with an item of clothing having light-emitting devices and a wiring loom for connecting the light-emitting devices the control unit. A peripheral device is attached to the item of clothing and is configured to generate environmental data. The environmental data is broadcast, after predetermined intervals, by radio transmission and each broadcast includes signature data identifying the peripheral device. The peripheral device includes a passive transponder including a data storage device for holding the signature data. The control unit energizes the transponder and a receiver 610 in the control unit receives the data transmitted by the transponder. Data storage in the processor 801 stores the transmitted signature data. The processor is then configured to only record environmental data that includes previously stored signature data. Many transmissions may be received, but only the associated ones are recorded.

Many types of peripheral device may be associates and more than one may be associated at the same time. Thus, a peripheral device may be configured to detect audio levels and the environmental data may include first signature data. Another peripheral device may be configured to detect gas concentrations and the resulting environmental data may include second signature data. Like previously described systems, a re-charging operation may result in the stored signature data being erased, while recorded environment data may be downloaded. Alternatively, or in addition, the downloaded data is transmitted to a base station in real time. The base station may also be used to authenticate devices, as previously described.

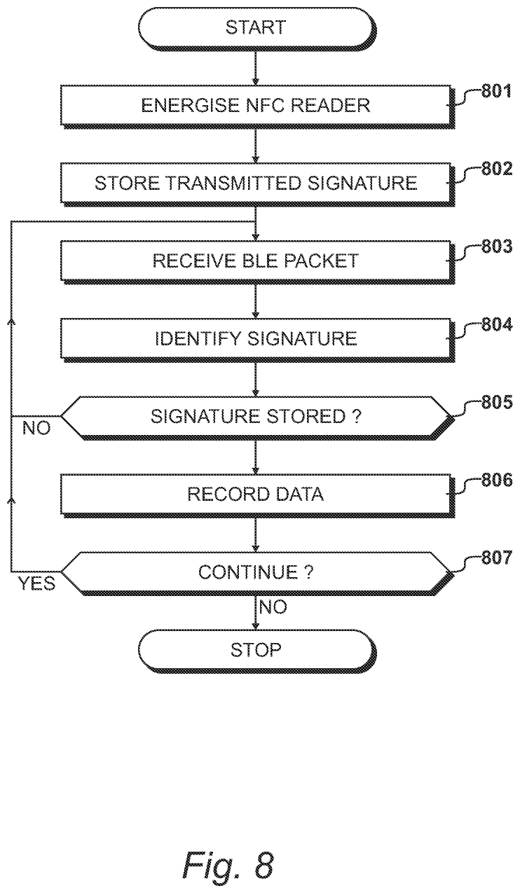

### FIG. 8

Operations performed by the control unit to achieve an association, as described with reference to FIG. 7, are shown in FIG. 8. After activation, the knocking operation (illustrated in FIG. 7) results in the NFC reader 610 being activated. Signature data is held by the NFC chip and when transmitted from the peripheral device, it is stored by the control unit at step 802.

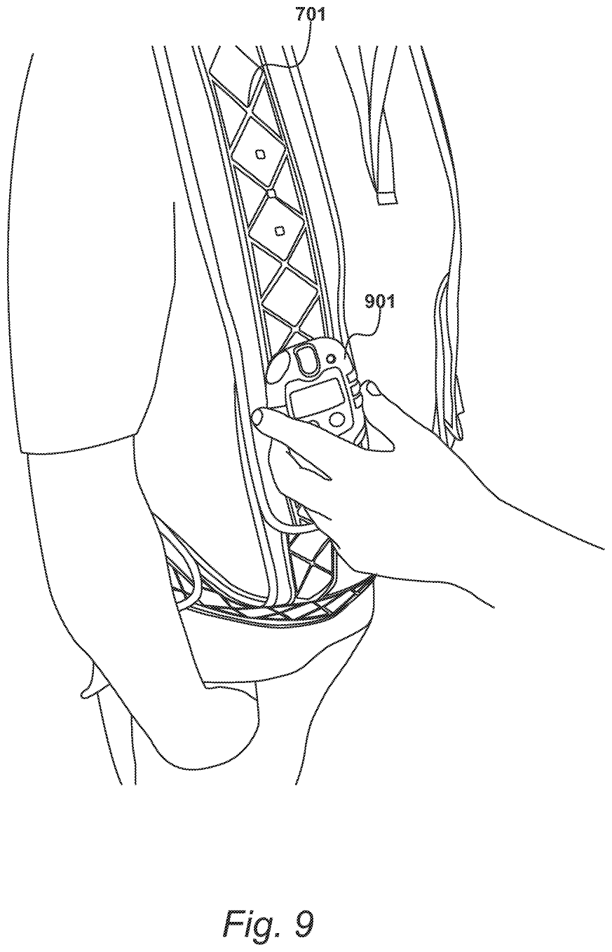

After associating in this way, the peripheral device may be attached to the item of clothing (as described with reference to FIG. 9) and the control unit may be attached to an embedded loom, as described with reference to FIG. 15.

At step 803, a BLE packet is received at the control unit. At step 804, the signature is identified and at step 805, a question is asked as to whether the signature has been stored. If this question is answered in the negative, the data is merely ignored and control returns to await the next packet. If the question asked at step 805 is answered in the affirmative, the environmental data is recorded at step 806. A question is then asked as to whether the process is to continue and when answered in the affirmative, control again awaits the next transmission.

### FIG. 9

An alternative item of clothing, in the form of a harness 901, is shown in FIG. 9. A peripheral device 902 has been associated with a control unit, by performing the knocking or tapping operation, as described with reference to FIG. 7. The peripheral device 901 is now attached to the harness 901.

In this embodiment, the peripheral device 902 is only mechanically supported by the harness. However, in some embodiments, the peripheral device may receive power from the embedded loom. Furthermore, in some embodiments, limited data transmission may also be possible over the loom. Under these circumstances, association (or pairing) is still desirable to facilitate data transmission at higher data rates.

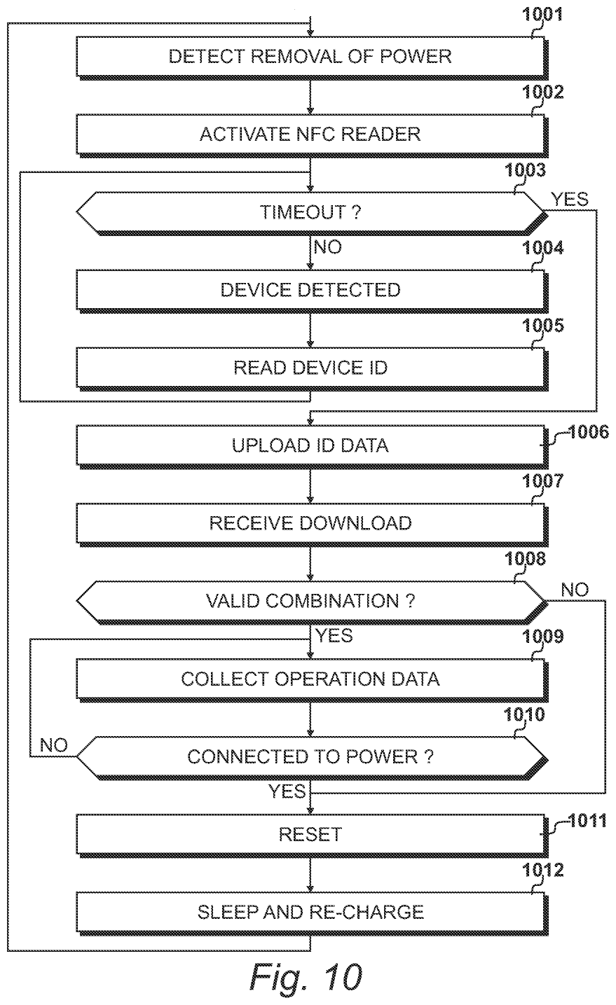

### FIG. 10

An example of operations that may be performed by the processor 601, in response to stored instructions, are detailed in FIG. 10. Initially, the processor 601 may enter a sleep state while the lithium-polymer cell (battery) 615 receives charge from bulk-charging device 509.

At step 1001, the processor 601 detects that a removal of charging current has occurred, resulting in the processor 601 being interrupted from a sleep state.

At step 1002, the NFC reader 609 is activated for a predetermined period of time. Thereafter, at step 1003, a question is asked as to whether a timeout has occurred and when answered in the negative, attempts are made to detect a device at step 1004. In response to a device being detected, an identification code is read at step 1005. Thus, in a typical mode of operation, a first code from a peripheral device is detected on a first iteration and a second code from an item of clothing is detected and read on a second iteration. The control unit may now be physically plugged into an integrated loom and secured within a waterproof pocket, prior to the question asked at step 1003 being answered in the affirmative.

After the timeout period, the question asked at step 1003 will be answered in the affirmative and the NFC reader 609 will be deactivated. This conserves power and also eliminates the risk of radio interference with the cellular module 602. Thus, at step 1006, the identification data for the peripheral device and the item of clothing are uploaded to the base station 305 via the cellular module 602. The base station determines whether the selected item of clothing can be used in combination with the selected control unit and the selected peripheral device. Thereafter, the base station transmits an access address to the control unit for the selected peripheral device if this determination is positive. Thus, after making a positive determination, the access address is received as a download from the base station 305 at step 1007. Alternatively, the downloaded data may represent a negative determination, such that the combination selected by the operative is not considered to be valid and is therefore not authorized for use.

In this embodiment, all codes are collected by the NFC reader at step 1002 before the information is transmitted by the cellular module 602. This approach reduces the possibility of the near field module 610 interfering with the cellular module 602. However, logically, the result is substantially similar to a code being read and then transited to the base station prior to the next code being read. With either approach, after completing these transactions, the control unit must await a positive approval from the base station before it can continue to the next stage.

A question is asked at step 1008 as to whether the combination is considered to be valid and when answered in the negative, a system reset occurs at step 1011, allowing the control unit to enter a sleep-and-recharge mode at step 1012. Other actions may be taken, such as raising an alarm but, essentially, the operative is not permitted to continue and communication functions are disabled.

In response to the question asked at step 1008 being answered in the affirmative, operational data is collected at step 1009. The collection and retransmission of this operational data continues and a question is asked at step 1010 as to whether the control unit has been reconnected to the bulk-charging device 509. Thus, when answered in the negative, the collection of operational data continues at step 1009.

Eventually, at the end of a shift, the control unit will be returned to the bulk-charging device 509 and the question asked at step 1010 will be answered in the affirmative. Thus, the control unit will reset, effectively erasing address codes and details of previous associations or pairings, such that it may enter a sleep mode and be recharged at step 1012.

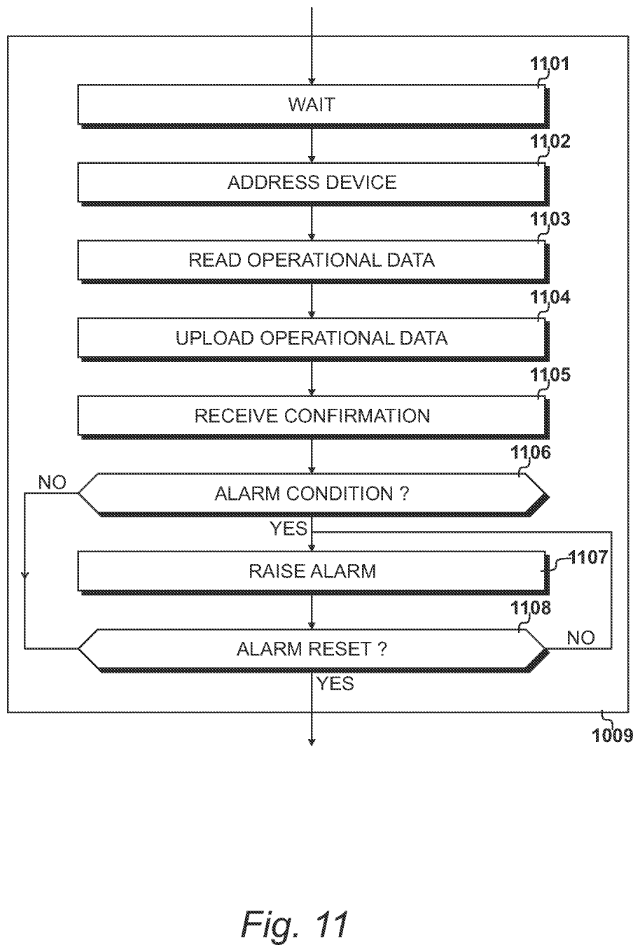

### FIG. 11

Procedure 1009 for collecting operational data is detailed in FIG. 11. Initially, at step 1101, the processor enters a wait state of typically two minutes, thereby specifying the periodicity for performing uploading operations.

After the wait period has elapsed, the peripheral device is addressed at step 1102. The addressing of the peripheral device is interpreted by the peripheral device as a request to download data that has been collected over an operational period. Consequently, the stored data is read at step 1103 using the locally established wireless connection.

At step 1104, the received data is uploaded via the cellular channel to the base station 305. At step 1105 a confirmation is received which may in turn include additional data identifying alarm conditions. Thus, at step 1106, a question is asked as to whether an alarm condition has been detected and, if this question is answered in the negative, control progresses to step 1010. Alternatively, if the question asked at step 1106 is answered in the affirmative, an alarm condition is raised at step 1107 until a reset condition is detected at step 1108. Thereafter, control is again directed to step 1010, whereafter normal operation may resume.

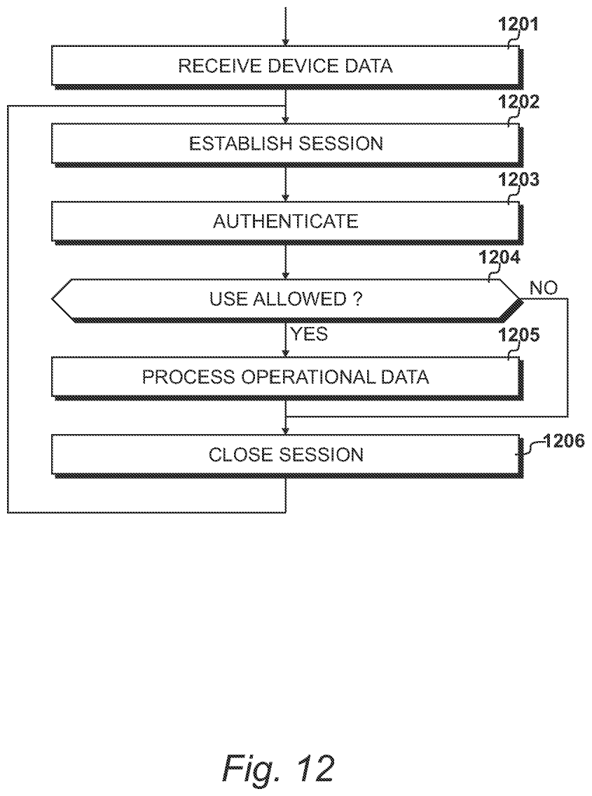

### FIG. 12

Procedures performed at the base station 305 in order to communicate with control units, are identified in FIG. 12. At step 1201 new data is received identifying devices. In an embodiment, details of a first device may be received followed by details of a second device. In this embodiment, the near-field module 610 may detect a first device, such as a peripheral device and details of this peripheral device may be transmitted by the cellular module 602. Thereafter, the near-field module 610 detects a further device, such as an item of clothing, whereafter details of this are uploaded by the cellular module 602.

In an alternative configuration, the near-field module 610 identifies a peripheral device and then also identifies an item of clothing. The near field device is then deactivated and the control unit is inserted within a pocket. Thereafter, identification data for the two (or possibly more) devices are uploaded, without the risk of any interference occurring with the near field transmissions.

Upon receiving data from a control unit, the base station 305 establishes a session at step 1202 and then performs an authentication procedure at step 1203. A session relates to communications with a particular control unit. In use, the base station will communicate with several (possibly very many) control units, with a unique session being instantiated for each.

After authentication at step 1203, a question is asked at step 1204 as to whether use is allowed. When the question asked at step 1204 is answered in the negative, the session is closed at step 1206 and data is downloaded to this effect, resulting in the question asked at step 1008 being answered in the negative. Alternatively, if use is allowed and a positive authentication has been made at step 1203, operational data will be received and processed at step 1205. Thereafter, the session will be closed at step 1206, possibly in response to the control unit being returned to the bulk-charging device 509.

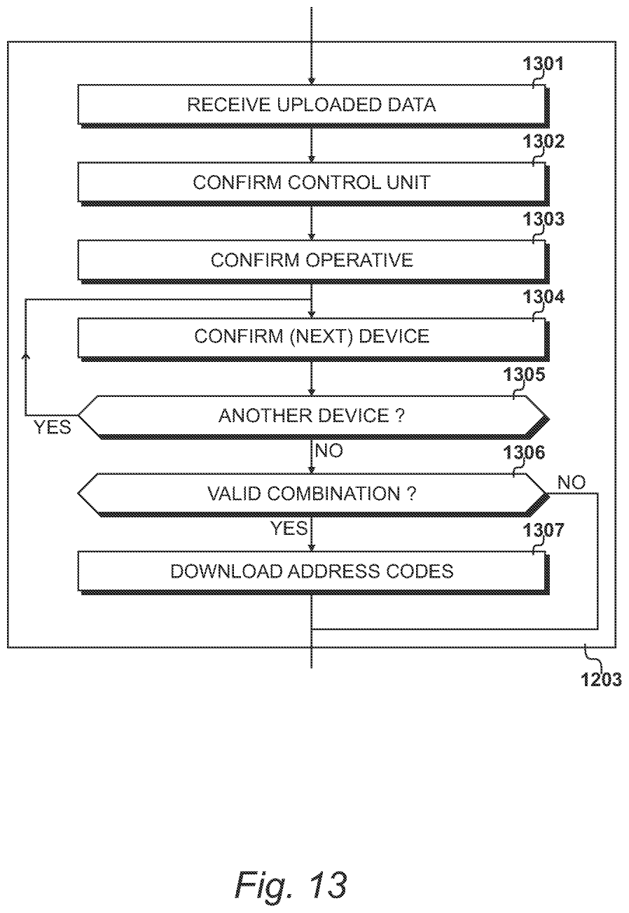

### FIG. 13

Procedure 1203 for performing an authentication process is detailed in FIG. 13. At step 1301 the uploaded data is received, identifying the peripheral device, the control unit and the item of clothing. Furthermore, given the allocation of items of clothing, this data also identifies a particular operative.

At step 1302 confirmation is made to the effect that the control unit is known to the system. Thereafter, at step 1303 an assessment is made to confirm that the operative has selected an appropriate control unit. Thereafter, at step 1304 peripheral devices are considered. Thus, the first peripheral device is selected and confirmation is made to the effect that it is appropriate for the operative to use this peripheral device with the selected control unit. Thereafter, at step 1305 a question is asked as to whether another peripheral unit has been attached and if answered in the affirmative, the next peripheral device is confirmed at step 1304. Thereafter, when all of the peripheral devices have been considered and the question asked at step 1305 is answered in the negative, a question is asked at step 1306 as to whether the devices considered previously present a valid combination. If answered in the affirmative, address codes are downloaded at step 1307.

Alternatively, if the combination is not considered valid and the question asked at step 1306 is answered in the negative, address codes are not downloaded and it is not possible for the control unit to become operational.

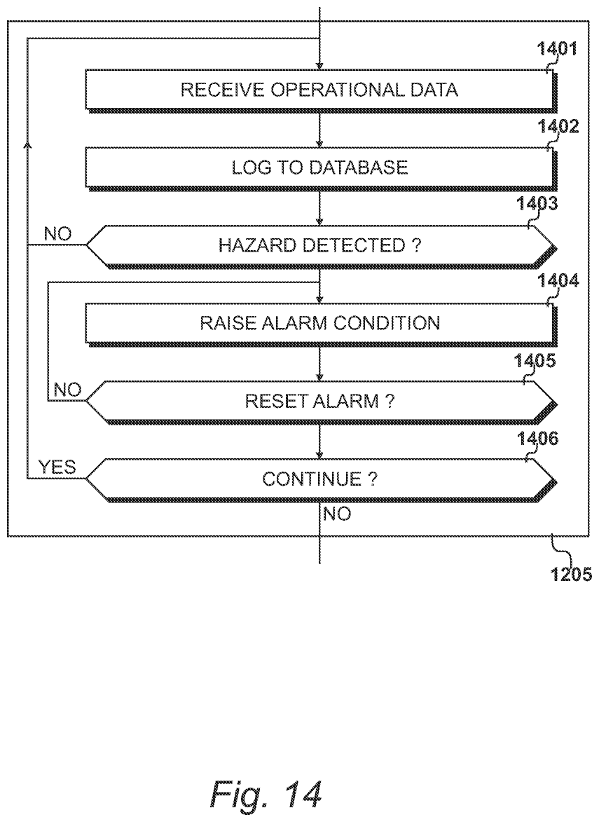

### FIG. 14

Procedure 1205 for processing operational data is detailed in FIG. 14. In response to the uploading of operational data from the control unit at step 1104, operational data is received at the base station 305 at step 1401. At step 1402, the received data is logged to the database system 306, thereby maintaining a historical record of the data received.

At step 1403, a question is asked as to whether a hazard has been detected. Normally, the question asked at step 1403 would be answered in the negative and the session would then wait for the reception of further operational data at step 1401. However, if a hazard is detected and the question asked at step 1403 is answered in the affirmative, an alarm condition is raised at step 1404. This alarm condition is then detected at step 1106 and a local alarm condition is raised at step 1107. The local alarm condition will continue until a reset signal is received.

A question is asked at step 1405 as to whether the alarm has been reset and if answered in the negative, the alarm condition will persist. However, eventually, the question asked at step 1405 will be answered in the affirmative and a question is then asked at step 1406 as to whether operations should continue.

Under some conditions, it may not be possible to continue the shift, due to the nature of the hazard. Thus, the question asked at step 1406 will be answered in the negative. If the nature of the hazard is less serious and can be dealt with locally, the question asked at step 1406 will answered in the affirmative and further operational data will then be received at step 1401.

### FIG. 15

An item of clothing in the form of a jacket 1501 is shown in FIG. 15. The jacket 1501 includes light-emitting devices 1502 on lapels and similar devices 1503 on arms. The light-emitting devices 1502, 1503 receive power and control data via an embedded loom 1504. After a control unit 502 has been used to read near field devices from one or more peripheral devices and read the near field device associated with the jacket, the loom 1504 is plugged into the control unit 502. As shown in FIG. 15, the control unit may then be supported within an internal pocket of the jacket 1501.

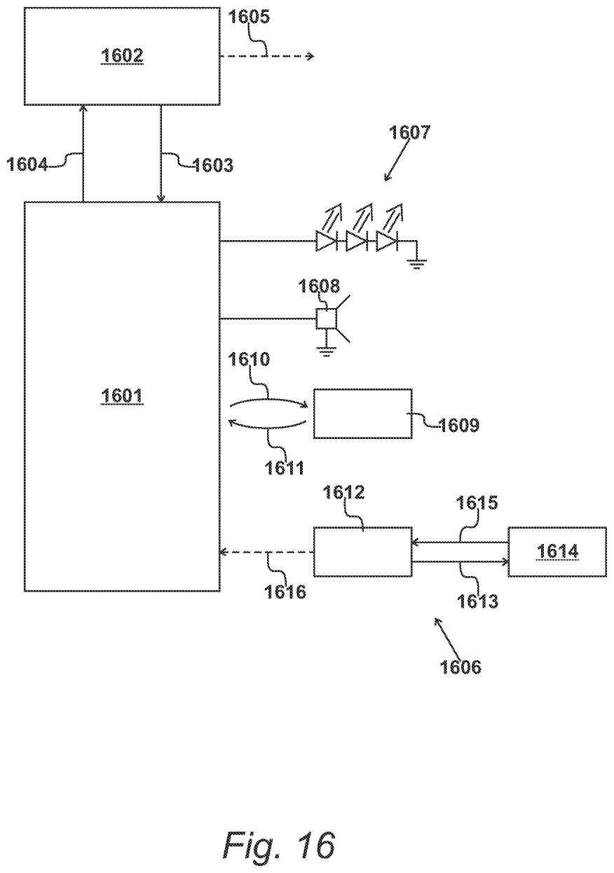

### FIG. 16

Given an item of clothing, such as that shown in FIG. 15, having warning devices attached thereto and a control unit, wherein the control unit is configured to receive warning signals, it is possible to provide an apparatus that conveys warning signals to a group of operatives in a hazardous environment. A schematic representation of such an apparatus is illustrated in FIG. 16. A control unit 1601 communicates with a base station 1602, using a cellular network or a data wireless network for example. Thus, control data is supplied from the base station 1602 to the control unit 1601 as illustrated by a first arrow 1603. Similarly, a second arrow 1604 confirms that operational data is transmitted from the control unit 1601 to the base station 1602.

In some situations, operational data of this type may be transmitted at an end of shift when communication becomes possible. However, in embodiments, the transfer of operational data is performed substantially in real time. This allows alerts and warnings to be transmitted to other control units within the environment, as illustrated by a third arrow 1605.

Differing types of peripheral devices 1606 communicate with the base station 1602. These include devices that are permanently attached to the item of clothing and will therefore automatically interface with the control unit 1601 when the control unit is connected, as described with reference to FIG. 15. In this way, the control unit 1601 provides energization signals to light-emitting devices 1607 and to an audio-output device 1608.

Other peripheral devices, such as a first peripheral device 1609 may require independent operations to be performed in order to achieve a pairing relationship with the control unit 1601. Thus, in some situations, the first peripheral device 1609 may pair with the control unit 1601 following well established protocols, such that communication is maintained from the control unit 1601 to the first peripheral device 1609 as illustrated by a fourth arrow 1610; with operational data being continually returned to the control unit 1601 as illustrated by a fifth arrow 1611. Alternatively, the first-peripheral-device 1609 may be configured only to provide end of shift data transfers, such that additional measures are required in order to achieve continual data transfer, as described with reference to FIG. 4.

In the embodiment of FIG. 16, a second-peripheral-device 1612 is provided that is configured to transmit second data as illustrated by a sixth arrow 1613, to a proximity-alarm-system 1614. The proximity alarm system 1612 is configured to receive a radio signal, as illustrated by a seventh arrow 1615 generated by beacons included on the proximity alarm system 1614.

Thus, the second peripheral device 1612 is sensitive to the amplitude of this received radio signal, such that when this amplitude exceeds a predetermined reference value, an energization signal is supplied to a contained haptic device. The second peripheral device 1612 is often located on an operative's helmet. Thus, if an operative comes too close to the hazardous equipment, the haptic device will vibrate and thereby warn the operative that they should take immediate action to avoid the hazard. Thus, the remote proximity alarm system 1614 continually transmits a radio signal as a warning to operatives.

When close enough to the proximity alarm system 1614, the second peripheral device 1612 raises a local alarm by energizing the haptic device and returns a radio signal to the proximity alarm system 1614; as indicated by the sixth arrow 1613. In addition, the control unit 1601 intercepts the radio transmission from the second peripheral device 1612 as indicated by dotted arrow 1616. The control unit 1601 is then in a position to raise an alert, which in turn generates a local alarm signal and relays similar alarm signals to other operatives within the environment.

Proximity detection systems and devices of this type are well established but are configured to operate independently and do not interface with additional equipment, such as the control unit 1610. Thus, for devices of this type, it is not possible to perform a pairing exercise of the type described with reference to FIG. 4. Firstly, devices of this type minimize the consumption of electrical power by entering a sleep mode and are then interrupted from this sleep mode upon detecting a radio signal. Consequently, without the radio signal being generated, the device is effectively inactive. Upon receiving a radio signal, the device is activated into performing a dedicated alarm function but this function does not include routines for performing a transfer of data. Historical data is not considered to be relevant and the device is specifically configured to only create an alarm when required and minimize energy consumption when not required.

It is possible for the first peripheral device, 1609 such as a gas detector, to generate a self-contained local warning signal. However, by being interfaced with the control unit 1601, it is possible for the other alarm devices, such as the light-emitting devices 1607 and the audio-output device 1608, to be activated when this local warning signal is generated. Furthermore, alerts of this type may also be uploaded to the base station 1602 and the base station will relay similar alert data to other operatives working within the environment. Not only does this achieve an immediate result, it also provides a data log of historical alerts that may be of use if there is a subsequent enquiry. However, within established environments, it is not possible for the proximity alarm system 1614 to operate in this way.

In an embodiment, the control unit 1601 is configured to intercept the second data, as illustrated by an eighth arrow 1616. The proximity alarm system 1614 generates a further radio signal when the first radio signal has been received, thereby allowing a general warning to be sounded. This second radio signal is intercepted and, in the embodiment, is processed by the control unit 1601. After being processed in this way, the alarm signal may be manipulated in a similar way to other alert signals, allowing the light-emitting devices 1607 and the audio-output device 1608 to be activated. Furthermore, proximity alarm data may now be uploaded to the base station 1602. However, it should be appreciated that these operations do not in any way affect the operations performed by the proximity alarm system and the second peripheral device 1612. There is no two-way communication between the devices, as there is for the first peripheral device 1609, but integration has been achieved by intercepting signals intended for another purpose.

Within this environment, it is therefore possible to provide a method of conveying warning signals to a group of operatives by interfacing a first peripheral device 1609 to a control unit 1601. A first alarm signal 1611 is conveyed from the first peripheral device to the control unit 1601. A visible warning 1607 is generated on an item of clothing in response to receiving this alarm signal. Furthermore, the method also includes intercepting a second alarm signal 1616 from a non-interfaced second peripheral device 1612, wherein the second alarm signal is intended for an independent proximity warning device 1614. In response to this, the visible warning is generated without directly communicating or affecting the second peripheral device 1612.

The invention claimed is:

1. An apparatus for use in a hazardous environment, comprising:
a control unit including a processor and a battery;
an item of clothing having light-emitting devices and a wiring loom for connecting said light-emitting devices to said control unit; and
a peripheral device attached to said item of clothing, wherein:
said peripheral device is configured to generate environmental data and broadcast said environmental data after predetermined intervals by radio transmission;
each said broadcast includes signature data identifying said peripheral device;
said peripheral device includes a passive transponder including a data storage device for holding said signature data;
said control unit includes an energizing device for energizing said passive transponder, a receiver for receiving data transmitted from said passive transponder and a data storage device for storing transmitted signature data; and
said processor is configured to only record environmental data that includes previously stored signature data.

2. The apparatus of claim 1, wherein:
said control unit includes a knock-detection device; and
said processor is configured to activate said energizing device in response to a knock being detected by said knock-detection device.

3. The apparatus of claim 1, wherein:
said peripheral device is configured to detect audio levels;
said environmental data represents detected audio levels; and
said environmental data representing audio levels includes first signature data.

4. The apparatus of claim 1, wherein:
said peripheral device is configured to detect gas concentrations;
said environmental data represents gas concentrations; and
said environmental data representing gas concentrations includes second signature data.

5. The apparatus of claim 1, wherein:
said item of clothing is a jacket;
said jacket includes light-reflective material;
said jacket a plurality of light-emitting strips; and
each light-emitting strip of said plurality of light-emitting strip includes plural of said light-emitting devices.

6. The apparatus of claim 1, wherein said peripheral device is configured to broadcast in accordance with an unpaired Bluetooth radio data transmission protocol.

7. The apparatus of claim 1, wherein said passive transponder is a near-field transponder.

8. The apparatus of claim 1, wherein said data storage device of said control unit is configured to store plural signature data, such that environmental data from respective peripheral devices are recorded.

9. The apparatus of claim 1, wherein:
said battery is a re-chargeable battery;
said control unit is configured for connection to facilitate re-charging of said battery; and
said processor is configured to re-set said data storage device of said control unit during a re-charging operation.

10. The apparatus of claim 1, wherein:
said control unit includes a communication device for communicating with a base station; and
said control unit is configured to transmit an identification code received from a peripheral device and only permit further communication with said peripheral device upon receiving an authentication code from said base station.

11. A method of receiving environmental data from a peripheral device, comprising steps of:
knocking a peripheral device against a control unit;
attaching said peripheral device to an item of clothing, such that said peripheral device is mechanically supported;
connecting said control unit to a wiring loom in said item of clothing, wherein said control unit operates light-emitting devices attached to said item of clothing; and
locating said control unit within said item of clothing to receive environmental data during an operation shift, wherein:
in response to said knocking step, said control unit energizes a passive transponder attached to said peripheral device;
said passive transponder transmits held signature data in response to being energized;
said control unit stores said transmitted signature data; and
said control unit only records environment data that includes stored signature data.

12. The method of claim 11, wherein said environmental data is periodically broadcast by said peripheral device, wherein each said broadcast includes said signature data.

13. The method of claim 11, wherein:
said peripheral device is configured to detect audio levels;
said environmental data represents detected audio levels; and
said environmental data representing audio levels includes first signature data.

14. The method of claim 11, wherein:
said peripheral device is configured to detect gas concentrations;
said environmental data represents gas concentrations; and
said environmental data representing gas concentrations includes second signature data.

15. The method of claim 11, wherein:
said item of clothing is a jacket;
said jacket includes light-reflective material;
said jacket a plurality of light-emitting strips; and
each light-emitting strip of said plurality of light-emitting strip includes plural of said light-emitting devices.

16. The method of claim 11, wherein said peripheral device is configured to broadcast in accordance with an unpaired Bluetooth radio data transmission protocol.

17. The method of claim 11, wherein said passive transponder is a near-field transponder.

18. The method of claim 11, wherein plural signature data are stored, such that environmental data from respective peripheral devices are recorded.

19. The method of claim 11, wherein stored signature data is erased during a re-charging operation.

20. The method of claim 11, wherein:
said control unit transmits an identification code received from a peripheral device to a base station; and
further communication between said peripheral device and said control unit is only permitted upon receiving an authentication code from said base station.
